(19) United States
(12) Patent Application Publication
(10) Pub. No.: US 2005/0235242 A1
(43) Pub. Date: Oct. 20, 2005

(54) Semiconductor integraged circuit device and method of routing interconnections for semiconductor IC device

(75) Inventor: Yasuhiro Waizumi, Kanagawa (JP)

Correspondence Address: YOUNG & THOMPSON, 745 SOUTH 23RD STREET, 2ND FLOOR, ARLINGTON, VA, 22202, US

(73) Assignee: NEC ELECTRONICS CORPORATION, KANAGAWA (JP)

(21) Appl. No.: 11/080,513

(22) Filed: Mar. 16, 2005

(30) Foreign Application Priority Data
Mar. 31, 2004 (JP) 2004-104887

(51) Int. Cl. G06F 17/50

(52) U.S. Cl. 716/12; 716/14

(57) ABSTRACT

A method of routing interconnections for a semiconductor integrated circuit device, which has a plurality of pads arranged in a first direction along a side of a chip and a plurality of slots arranged in an inner area of the plurality of pads, includes: (A) selecting such pads applicable to power supply as power pad candidates from the plurality of pads, each power pad candidate being arranged such that two interconnections perpendicular to the first direction are connectable without bending from the each power pad candidate to two adjacent slots of the plurality of slots; (B) specifying some of the power pad candidates as specific power pads each of which is used for supplying power to corresponding two adjacent slots; and (C) routing two interconnections between the each specific power pad and the corresponding two adjacent slots.

### BACKGROUND OF THE INVENTION

1. Field of the Invention

The present invention relates to a semiconductor IC (integrated circuit) device and a method of routing interconnections for the semiconductor IC device. More particularly, the present invention relates to power supply of a semiconductor IC device and a method of routing power supply interconnections for the semiconductor IC device.

2. Description of the Related Art

In recent years, semiconductor IC devices manufactured by using a semi-custom technique have become vastly used. In order to bring differential products to the market as immediately as possible, it is demanded to shorten the development period for a semiconductor IC device. To achieve the purpose, the semi-custom technique is employed.

According to the semi-custom technique, a variety of cells (components) respective of which have basic functions are designed beforehand and provided. Such a variety of cells are combined when forming a user specific circuit (application circuit). That is, the cells are arranged on a chip and interconnections are provided between the cells in accordance with the customer's request. Thus, the development period for the user specific circuit can be reduced.

In a semiconductor IC device, the number of terminals and the placement of the terminals are constrained by a basic structure. While in the development of a product, the number of terminals and logical capacity of a semiconductor IC device are significant factors to determine usability of the device for users.

Japanese Unexamined Patent Publication JP-P2001-230377 discloses a technique regarding a semiconductor IC device which has a plurality of input/output interface cells (I/O cells) and a plurality of pads connected to the plurality of I/O cells. The plurality of pads are arranged at a minimum pad pitch and a modified pad pitch. The minimum pad pitch corresponds to a case where an interval between adjacent pads is set as short as possible. As for the adjacent pads arranged at the minimum pad pitch, lead wires are provided not to contact one another.

Japanese Unexamined Patent Publication JP-P2003-086694 discloses a semiconductor device having a semiconductor chip, a plurality of pads, and internal wirings. Active elements are formed within the semiconductor chip, and the plurality of pads are provided for the semiconductor chip. The interior wirings are connected in units of multiple pieces to at least one of the plurality of pads. That is, a dummy IO slot is used as a power slot.

### SUMMARY OF THE INVENTION

In an aspect of the present invention, a method of routing interconnections for a semiconductor integrated circuit device is provided. Here, the semiconductor integrated circuit device has: a plurality of pads arranged in a first direction along a side of a chip; and a plurality of slots arranged in an inner area of the plurality of pads. The method according to the present invention includes: (A) selecting such pads applicable to power supply as power pad candidates from the plurality of pads, each of the power pad candidates being arranged such that at least two interconnections substantially perpendicular to the first direction are connectable without bending from the each power pad candidate to two adjacent slots of the plurality of slots; (B) specifying some of the power pad candidates as specific power pads each of which is used for supplying power to corresponding two adjacent slots of the plurality of slots; and (C) routing at least one interconnection between the each specific power pad and the corresponding two adjacent slots.

In the above-mentioned (B) specifying step, a predetermined number of pads of the plurality of pads are first allocated as power pads for power supply. Then, other pads of the plurality of pads are allocated as signal pads for signal input. When the signal pads are deficient by a certain number, the certain number of the power pads are allocated as additional signal pads for signal input. In order to compensate for the lack of the power pads, the certain number of the power pad candidates are selected as the specific power pads. Then, the two interconnections substantially perpendicular to the first direction are connected without bending between each specific power pad and the corresponding two adjacent slots, respectively. In other words, each specific power pad covers two adjacent slots.

Thus, according to the method of routing interconnections, it is possible to increase the number of signal pads (signal terminals) while securing the power supply capability. In other words, it is possible to determine the power pads used for the power supply while increasing the signal pads and securing the power supply capability. Accordingly, such an event where a chip size must be increased due to a shortage of the signal pads can be prevented. Therefore, a semiconductor IC device can be provided at a lower cost.

In another aspect of the present invention, a semiconductor integrated circuit device has: a plurality of pads arranged in a first direction along a side of a chip, the plurality of pads including power pads user for power supply; a plurality of slots arranged in an inner area of the plurality of pads; and at least two interconnections substantially perpendicular to the first direction connected without bending between one of the plurality of power pads and two adjacent slots of the plurality of slots, respectively.

### BRIEF DESCRIPTION OF THE DRAWINGS

The above and other objects, advantages and features of the present invention will be more apparent from the following description taken in conjunction with the accompanying drawings, in which:

FIG. 1 is a view showing an internal layout of a semiconductor IC device according to an embodiment of the present invention;

FIG. 2 is a view showing a positional relationship between pads and slots according to the embodiment of the present invention;

FIG. 3 is a view showing a positional relationship between pads and slots according to the embodiment of the present invention; and

FIG. 4 is a flowchart showing a method of determining power pad candidates according to the embodiment of the present invention.

### DESCRIPTION OF THE PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposed.

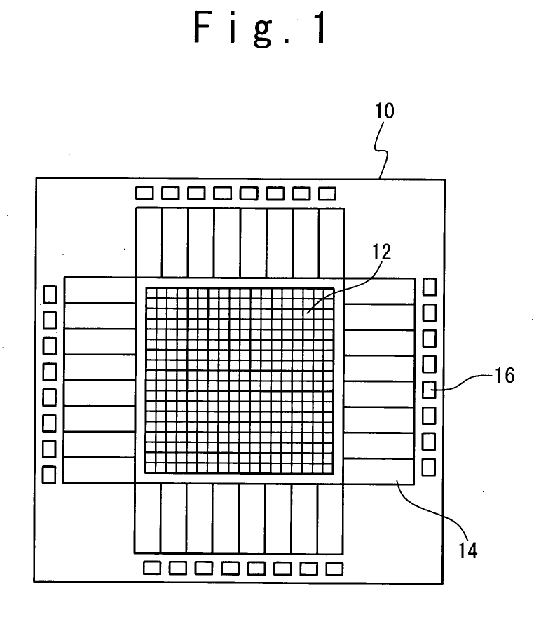

FIG. 1 is a view showing an internal layout of a semiconductor IC (integrated circuit) device 10 according to an embodiment of the present invention. The semiconductor IC device (semiconductor IC chip) 10 has an input/output (I/O) pad region, an I/O buffer region, and an internal cell region 12.

The I/O pad region corresponds to an outermost region of the chip. In the I/O pad region, a plurality of pads 16 are arranged regularly along four sides of the chip. With respect to one side of the chip, the pads 16 are arranged in a direction (first direction) along the one side, as shown in FIG. 1. Also, the pads 16 are arranged at a regular interval. The plurality of pads 16 are used for connecting between the semiconductor IC device 10 and lead frames of a package. A pad 16 and a lead frame are connected together, for example, through a wire bonding. A pad 16 and a lead frame may be bonded together by other techniques depending on the package type.

The I/O buffer region corresponds to a peripheral region of the chip and to an inner region of the I/O pad region. In the I/O buffer region, a plurality of slots 14 are arranged regularly along the plurality of pads 16. With respect to one side of the chip, the slots 14 are arranged to be contiguous with one another in a direction (first direction). The slots 14 are used for connecting between the pads 16 and circuits in the internal cell region 12. As to a slot 14 used for inputting and outputting signals, an I/O buffer circuit and a protection circuit which protects a circuit in the internal cell region 12 from an excess voltage are arranged. As to a slot 14 used for supplying electric power, the slot 14 is designed to reduce voltage drop, since it supplies the electric power to the internal cell region 12.

In the internal cell region 12, a plurality of cells are arranged, in which each cell is an element of a logic circuit. The cells are combined to form an internal circuit(s), thereby to create a desired circuit (application circuit). The number of the cells determines a scale of an application circuit to be realized. In other words, a scale of an application circuit is constrained by a chip size. Also, it is possible to estimate power consumption based on the scale of the application circuit to be realized.

Conversely, a chip size to be used can be estimated on the basis of such information as the number of signal lines to be used, a required circuit scale, a required power consumption and the like. For example, a chip size is determined based on a required circuit scale. Also, a chip size is often determined based on the number of pads or the number of slots in accordance with the number of signal lines to be used. The larger chip size should be adopted, as the number of pads or the number of slots increases in accordance with the number of signal lines. In this case, however, the cost is also increased. Therefore, in a case when a circuit scale is not so large, the number of signal lines are suppressed in order to avoid the enlargement of the chip size.

The number of pads 16 that can be arranged is determined by the chip size. The pads 16 are allocated for signal lines and for power supply lines. The pad 16 allocated for a signal line and used for signal input/output is referred to as a “signal pad” hereinafter. On the other hand, the pad 16 allocated for a power supply line and used for power supply is referred to as a “power pad” hereinafter. In many cases, the number of power pads is reduced when the total number of pads must be decreased. Reducing such power pads would be effective in such a case where the circuit scale can be estimated to be sufficient to sustain a supply capacity of the power current that is reduced by that reduction. However, in many cases, an allowable level of the reduction can not be known until a design of all circuits is completed. For this reason, in the event that the number of signal lines can not be reduced, the chip size is increased by one rank to avoid changing the chip size after the completion of the circuit design.

If a limit of the number of reducible power pads is known in the estimation stage, the chip size need not be increased, unlike the above-described case. According to the present invention, candidates of the power pads are determined before the estimation stage. When the power consumption is estimated, a number of power pads corresponding to the estimated power consumption are selected from the candidates. Such candidates of the power pads applicable to the power supply are referred to as “power pad candidates”.

The power pad candidates are selected from the plurality of pads 16 shown in FIG. 1. The selection of the power pad candidates will be described below.

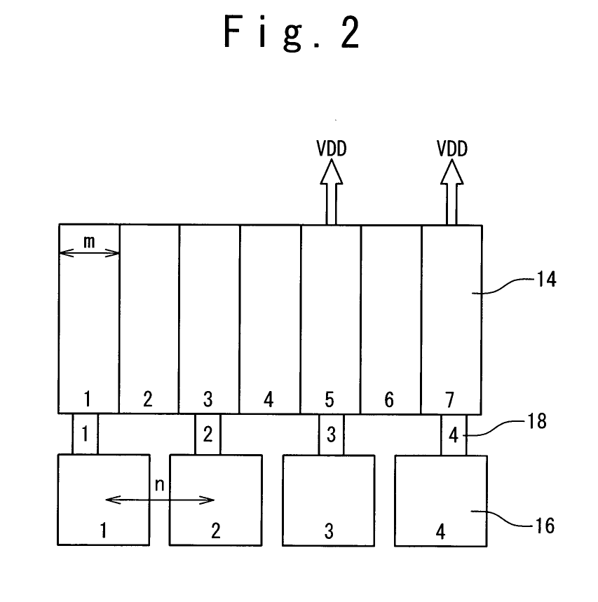

FIG. 2 shows a magnified view of the slots 14 and pads 16 which are arranged along a side of the chip. As described above, the pads 16 are arranged in a direction along a side of the chip, which is referred to as a “first direction”. The slots 14 are also arranged in the first direction to be contiguous with one another. A direction substantially perpendicular to the first direction is referred to as a “second direction” hereinafter. The slots 14 are located in the second direction from the pads 16.

A pad 16 and a slot 14 are connected through a pad interconnection 18 such that a length of the pad interconnection 18 becomes minimum, as shown in FIG. 2. That is to say, the pad interconnection 18 is perpendicular to the first direction and along the second direction, and is routed without bending (jog) from the pad 16 and the slot 14. In FIG. 2, a pad 16-1 and a slot 14-1 are connected together through a pad interconnection 18-1, a pad 16-2 and a slot 14-3 are connected together through a pad interconnection 18-2, a pad 16-3 and a slot 14-5 are connected together through a pad interconnection 18-3, and a pad 16-4 and a slot 14-7 are connected together through a pad interconnection 18-4. For example, when the power VDD is supplied to the internal circuits through the slots 14-5 and 14-7, the power is supplied to the pads (power pads) 16-3 and 16-4 connected to the slots 14-5 and 14-7. The slots 14-1 and 14-3 connected to the other pads (signal pads) are used for inputting and outputting signals. In FIG. 2, as for a slot 14-6 between the slot 14-5 and the slot 14-7, no connectable partner pad is available. The slot 14-6 is left as an empty slot.

To reduce constraints of the internal circuits, the slot to be connected to the pad 16-3 may be changed from the slot 14-5 to the slot 14-6. In this case, the number of slots connectable to pads is increased. The slots 14-1 to 14-5 become connectable to the pad 16-1 or the pad 16-2, so that degree of freedom of the arrangement in the internal circuit is enhanced. In this case, however, a jog which is a bent portion appears in the pad interconnection 18-3 connecting from the pad 16-3 to the slot 14-6. Such a jog can influence an interconnection route in a surrounding portion thereof, and can be a constraint on the routing of interconnections. The routing of interconnections should be performed such that the jogs are reduced as possible. According to the present invention, the pad interconnections 18 are routed without bending (jog).

It should be noted that the current-carrying capacity of a pad 16 is larger than that of a slot 14. According to the present invention, a single power pad 16 can be correlated to a plurality of slots 14. Such a pad 16 connectable without a jog to a plurality of slots 14 is selected as a power pad candidate. Then, the power pads used for power supply are specified from the power pad candidates. In this manner, correlations between the pads and slots are determined.

More specifically, the “power pad candidates” applicable to power supply are previously selected from the plurality of pads 16. Each of the power pad candidates is selected on the basis of a criterion that two pad interconnections 18 along the second direction are connectable without bending from the each power pad candidate to two adjacent slots 14.

Then, in a designing step, a predetermined number of pads 16 of the plurality of pads 16 are allocated as “power pads (preliminary power pads)” according to the required power consumption. Here, it is preferable from the view point of the power supply balance to distribute the preliminary power pads. Therefore, in the present stage, one preliminary power pad is correlated and allocated to one slot 14.

Next, other pads 16 of the plurality of pads 16 are allocated as “signal pads”. The signal pad is allocated to a signal line, and is used for inputting and outputting signals. The number and the positions of the signal lines differ depending on chips (user's application circuits). Usually, the number of slots 14 is larger than the number of pads 16. Even when all the necessary signal lines are allocated to a certain number of the slots 14, it is not ensured that all of the certain number of slots 14 can be connected to the pads 16. When there are enough signal pads 16 connectable to the slots 14 to which the necessary signal lines have been allocated, the circuit design is continually proceeded.

When the signal pads 16 are deficient by a certain number, the certain number of the preliminary power pads mentioned above are allocated as “additional signal pads” for the signal lines. In order to compensate for the lack of the power pads, the certain number of the “power pad candidates” are selected as “specific power pads”. Each of the specific power pads is used for supplying power to corresponding two adjacent slots 14. In other words, each specific power pad covers two adjacent slots 14. As described above, some of the power pad candidates are specified as the specific power pads in order to secure the power supply capability. Then, at least one pad interconnection 18 is routed between each specific power pad 16 and the corresponding two adjacent slots 14. Typically, two pad interconnections 18 are connected without bending between each specific power pad 16 and the corresponding two adjacent slots 14, respectively.

Thus, according to the method of routing interconnections, it is possible to increase the number of signal pads (signal terminals) while securing the power supply capability. In other words, it is possible to determine the power pads used for the power supply while increasing the signal pads and securing the power supply capability. Accordingly, such an event where a chip size must be increased due to a shortage of the signal pads can be prevented. Therefore, a semiconductor IC device can be provided at a lower cost.

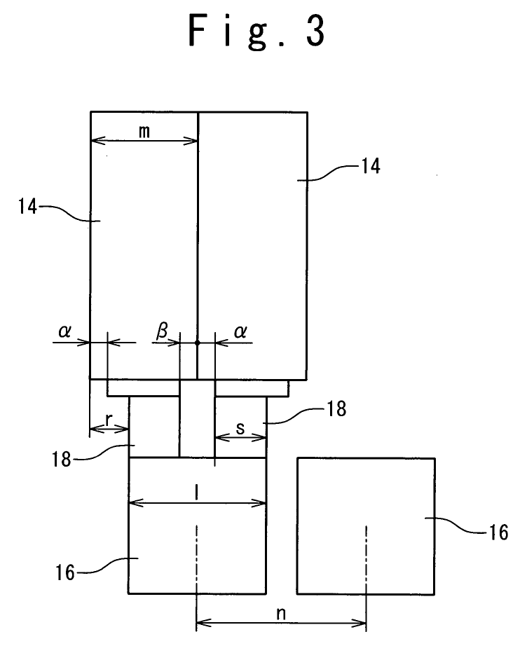

A method of selecting the above-mentioned power pad candidates according to the present invention will be described below in further detail. FIG. 3 shows a positional relationship between a power pad candidate and the two adjacent slots 14. The two adjacent slots 14 are arranged next to each other in the first direction. The two adjacent slots 14 includes a first slot 14 located in the left side (first side) and a second slot 14 located in the right side (second side). The first and the second slots 14 may be hereinafter referred to as the first slot 14-1 and the second slot 14-2, respectively.

The definition of the positional relationship is as follows. A width along the first direction of each pad 16 is “l”, which is referred to as a pad width. A width along the first direction of each slot 14 is “m”, which is referred to as a slot width. A width along the first direction of a pad interconnection 18 is “s”, which is referred to as a pad interconnection width. A distance between centers of two adjacent pads 16 is “n”, which is referred to as a pad pitch. Also, there are regions in the slot 14 to which the connection of the pad interconnection 18 is forbidden. The width along the first direction of the forbidden region is called a clearance. As shown in FIG. 3, the clearance in the left side of each slot 14 is “α”, which is referred to as a left clearance. The clearance in the right side of each slot 14 is “β”, which is referred to as a right clearance. A distance between an edge of the first side of the first slot 14-1 and an edge of the first side of the pad (power pad candidate) 16 is “r”. The slots 14 and the pads 16 are placed at the same width and the same pitch.

According to the present embodiment, the pads 16 to which at least two pad interconnections 18 are connectable are selected as the power pad candidates. Since the left clearance α and the right clearance β are necessary, the pad width l of a power pad candidate is expressed as l≧2s+α+β (see FIG. 3). Also, according to the present embodiment, one power pad candidate is connectable to at least two adjacent slots 14 through two pad interconnections 18, respectively. Since at least one pad interconnection 18 is connected to the first slot 14-1, the slot width m is larger than the sum of the distance r, the pad interconnection width s, and the right clearance β. That is, the slot width m is expressed as r+s+β≦m. Also, since at least one pad interconnection 18 is connected to the second slot 14-2, the following equation must be satisfied: r+l≧m+α+s. Thus, the pads 16 which satisfy the following three equations are selected as the power pad candidates:
l≧2s+α+β (1)
r+s+β≦m (2)
r+l≧m+α+s (3)

where,

l is the pad width,

m is the slot width,

n is the pad pitch,

s is the pad interconnection width,

r is the distance from the left edge of the slot to the left edge of the pad,

α is the left clearance of the slot, and

β is the right clearance of the slot.

The distances “r” for respective pairs of a slot and a pad can be determined automatically after an initial value is set for a base pad (initial pad), for example, a pad located at the left end. The initial value of the distance r can be arbitrary.

With reference to the above-mentioned example shown in FIGS. 2 and 3, the method of selecting power pad candidates will be explained. As shown in FIG. 2, the numbers are assigned to the slots 14 and the pads 16 sequentially from the left. With respect to a slot 14-i and a pad 16-j, the distance r from the left edge of the slot 14-i to the left edge of the pad 16-j is represented as r(i,j). In this case, the distance r(i,j) can be expressed as follows:
r(i,j)=r(1,1)+n×(j−1)−m×(i−1) (4)

where the distance r(1,1) is the initial value associated with the left edge. By applying the distance r(i,j) to the above equations (1) to (3), combinations of i and j which satisfy the above equations (1) to (3) can be extracted. With respect to the pair (i,j) satisfying the condition, the pad 16-j can be connected to the slots 14-i and 14-(i+1) through at least one pad interconnection 18.

When a chip to be used is determined, the pad width 1, the slot width m, the pad pitch n, the pad interconnection width s, the left clearance α, and the right clearance β are given in accordance with a basic configuration. Then, pads 16 having the distances r which satisfy the following equation, which can be derived from the above-mentioned equations, are selected to be the power pad candidates:
m+α+s−l≦r≦m−s−β (5)

The selection and determination of the power pad candidates can be achieved by a computer program executed by a computer. The computer program (software product) may be stored in a recordable medium.

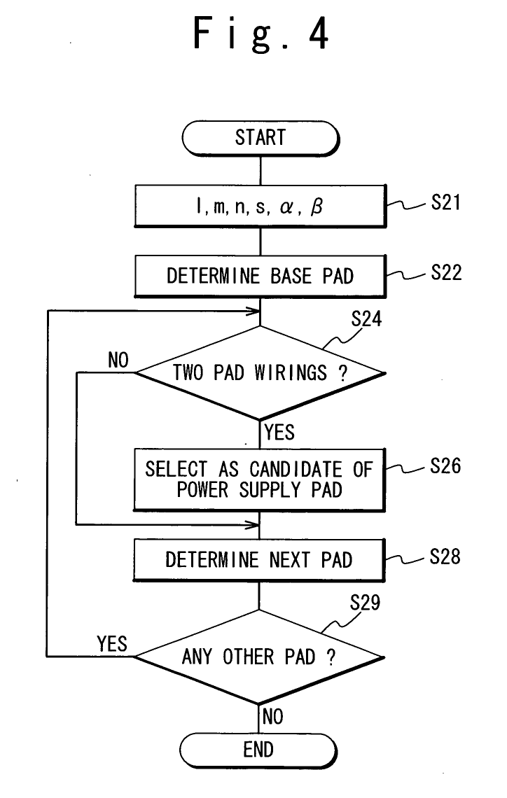

FIG. 4 is a flowchart which summarizes the method of determining the power pad candidates according to the present embodiment. First, a chip size is determined in accordance with a desired circuit scale. As a result, the pad width l, the slot width m, the pad pitch n, the pad interconnection width s, the left clearance α, and the right clearance β are given (Step S21). These values are fixed according to the chip size. Here, it is verified whether the above-mentioned equation (1) is satisfied or not.

Next, a base pad (initial pad) is determined which is used as a reference of the positions (Step S22). For example, the pad 16-1 located at the left end (see FIG. 2) is determined as the base pad. As a result, an initial value r(1,1) of the distance from the left edge of the slot 14-1 to the left edge of the pad 16-1 is obtained. It is preferable that the positions of the base pad and the base slot are preliminarily determined for every chip, and are prepared for use as chip design data.

Next, whether the above equation (5) is satisfied or not is checked with regard to the slots located around the selected pad (Step S24). In the present step, the above condition expressed by the equation (5) can be verified between all the pads 16 and all the slots 14. However, it is enough to verify the relations between the selected pad 16 and the slots 14 located around the selected pad 16, which will be explained afterward.

When the equation (5) is satisfied (Step S24; Yes), the slot 14-i and the slot 14-(i+1) are connectable to the selected pad 16-j. That is to say, the selected pad 16-j is a power pad candidate (Step S26).

If the equation (5) is not satisfied (Step S24; No), the numbers i and j are changed to perform the verification for the next pad (Step S28). If any pad 16-j or any slot 14-i to be verified still remains (Step S29; Yes), the procedure returns to the above-mentioned Step S24 and similar steps are repeated again. The above-mentioned steps are iterated until neither a pad 16 nor slot 14 to be verified remains (Step S29; NO). If necessary, another side of the chip may be verified.

When one power pad candidate is determined, the other power pad candidates may be determined based on repetition of the arrangement pattern of the pads 16 and the slots 14. More specifically, the arrangement pattern is indicated by a least common multiple of the slot width m and the pad pitch n. It may not be necessary to verify all the relations between pads 16 and slots 14.

Description will now be given in more detail by using an example with numeric values. A case is assumed in which the pad width l is 60 μm, the slot width m is 40 μm, the pad pitch n is 70 μm, the pad interconnection width s is 20 μm, the left clearance α is 2 μm, and the right clearance β is 2 μm. In this case, the above equation (5) can be expressed as: 2≦r≦18. Therefore, a pair of a slot 14 and a pad 16 which satisfies the relationship (2≦r≦18) should be searched for. Also, it is assumed that the initial value r(1,1) in the equation (4) which indicates the distance from the left edge of the slot 14-1 to the left edge of the pad 16-1 is 5.

First, such slots 14 satisfying the above condition are searched for with respect to the pad 16-1. Since the distance r(1,1) is 5, it is found that two slots 14-1 and 14-2 can be connected to the pad 16-1 through two interconnections without bending (jogs), respectively. That is to say, the pad 16-1 can be selected as a power pad candidate. Also, the distance r(2,1) is −35, it is found that a combination of the slots 14-2 and 14-3 can not be connected to the pad 16-1 without jogs.

As for the pad 16-2, the distance r(2,2) is 35 and the distance r(3,2) is −5. Thus, there is no pair satisfying the above condition. The pad 16-2 can not be a power pad candidate. Also, as for the pad 16-3, the distance r(4,3) is 25 and the distance r(5,3) is −15. Thus, there is no pair satisfying the above condition (2≦r≦18). The pad 16-3 can not be a power pad candidate.

As for the pad 16-4, since the distance r(6,4) is 15, it is found that two slots 14-6 and 14-7 can be connected to the pad 16-4 through two interconnections without bending (jogs), respectively. That is to say, the pad 16-4 can be selected as a power pad candidate.

Since the slot width m is 40 μm and the pad pitch n is 70 μm, the least common multiple length is 280 μm. Thus, an arrangement pattern appears repeatedly every 280 μm. The least common multiple length of 280 μm corresponds to seven slots 14 and four pads 16, as is represented in FIG. 2. In the present example, two power pad candidates (16-1 and 16-4) can be found in one arrangement pattern constituted by seven slots and four pads. The other power pad candidates can be found on the basis of the repletion of the arrangement pattern.

In this manner, the power pad candidates are selected and determined. At the stage of routing interconnections, not all the power pad candidates are necessarily used as the power pads. First, a predetermined number of pads 16 are allocated as preliminary power pads in accordance with the required power consumption. Then, other pads are allocated to signal pads (external terminals) connected to the required signal lines. When the signal pads are deficient by a certain number, the certain number of the preliminary power pads are allocated as additional signal pads. In order to compensate for the lack of the power pads, the certain number of the power pad candidates are selected as the specific power pads. In other words, one more slot 14 is allocated to a preliminary power pad which is one of the power pad candidates. Then, the two pad interconnections 18 substantially perpendicular to the first direction are connected without bending between each specific power pad 16 and the corresponding two adjacent slots 14, respectively. Namely, each specific power pad 16 covers two adjacent slots 14. In this manner, the power supply amount is secured.

A power pad candidate which is not allocated as a power pad may either be used as a signal pad or be remained unused.

In the above description, the left clearance α and the right clearance β are the same value for all the slots 14. However, the clearances can be different depending on the slots 14. In this case, the conditions expressed by the above equation (5) for the plurality of slots 14 may be different from each other.

Also, the left clearance α and the right clearance β can be 0. Such a case will be described below. In this case, the above-mentioned equations (1), (2), (3) and (5) can be modified into the following equations (1)′, (2)′, (3)′ and (5)′, respectively:
l≧2s (1)′
r+s≦m (2)′
r+l≧m+s (3)′
m+s−l≦r≦m−s (5)′

where,

l is the pad width,

m is the slot width,

s is the pad interconnection width, and

r is the distance from the left edge of the slot to the left edge of the pad.

The pads 16 which satisfy the above equations are selected as the power pad candidates. For example, a case is assumed in which the pad width l is 60 μm, the slot width m is 40 μm, the pad pitch n is 70 μm, the pad interconnection width s is 20 μm, the left clearance α is 0 μm, and the right clearance β is 0 μm. In this case, the above equation (5)′ can be expressed as: 0≦r≦20. Therefore, a pair of a slot 14 and a pad 16 which satisfies the relationship (0≦r≦20) should be searched for. Also, it is assumed that the initial value r(1,1) in the equation (4) which indicates the distance from the left edge of the slot 14-1 to the left edge of the pad 16-1 is 10. Since the slot width m is 40 μm and the pad pitch n is 70 μm, the least common multiple length is 280 μm and seven slots 14 and four pads 16 appear in one arrangement pattern. The arrangement pattern is iterated. Therefore, it is enough to retrieve the pads 16 satisfying the above conditions from the one arrangement pattern.

As a result of an examination, the following pairs are found to satisfy the above conditions; the distance r(1,1) is 10, the distance r(3,2) is 0, and the distance r(6,4) is 20. Thus, the pads 16-1, 16-2, and 16-4 can be selected as power pad candidates. The slots 14-1 and 14-2 can be connected to the pad 16-1 without jogs. The slots 14-3 and 14-4 can be connected to the pad 16-2 without jogs. The slots 14-6 and 14-7 can be connected to the pad 16-4 without jogs.

Here, the slots 14-1 and 14-2 are adjacent to each other, the slots 14-3 and 14-4 are adjacent to each other, and slots 14-6 and 14-7 are adjacent to each other. The left and the right clearances α and β are 0 μm. It is therefore possible to arrange two pad interconnections 18 in contact with one another. More specifically, one power pad candidate and corresponding two adjacent slots can be connected through “one pad interconnection” whose width is twice the width “s” mentioned above. In other words, the two adjacent slots 14 can be connected to one pad interconnection with double width, and the one pad interconnection can be connected one specific power pad. Also in this case, one specific power pad covers two adjacent slots 14.

In this manner, the power pad candidates are selected and determined. At the stage of routing interconnections, not all the power pad candidates are necessarily used as the power pads. First, a predetermined number of pads 16 are allocated as preliminary power pads in accordance with the required power consumption. Then, other pads are allocated to signal pads (external terminals) connected to the required signal lines. When the signal pads are deficient by a certain number, the certain number of the preliminary power pads are allocated as additional signal pads. In order to compensate for the lack of the power pads, the certain number of the power pad candidates are selected as the specific power pads. In other words, one more slot 14 is allocated to a preliminary power pad which is one of the power pad candidates. Then, at least one pad interconnection substantially perpendicular to the first direction is connected without bending between each specific power pad 16 and the corresponding two adjacent slots 14, respectively. Accordingly, the power supply amount is secured.

When the slot width m and the pad interconnection width s are narrow, three or more slots 14 can be correlated (connected) to one pad 16. For example, a case is assumed in which the pad width l is 60 μm, the slot width m is 25 μm, the pad pitch n is 70 μm, the pad interconnection width s is 10 μm, the left clearances α is 1 μm, and the right clearance β is 1 μm. In this case, pairs (i,j) satisfying the relationship (−24≦r≦14) should be retrieved.

With respect to the pad 16-1, it is found that the distance r(1,1) is 2. Thus, the slots 14-1 and 14-2 can be connected to the pad 16-1 without jogs. In addition, it is found that the distance r (2,1) is −23. Thus, the slots 14-2 and 14-3 can be also connected to the pad 16-1 without jogs. That is to say, the pad 16-1 and the slots 14-1 to 14-3 can be connected together without jogs (referred to as a triple pad net). The pad 16-1 can be selected as a power pad candidate.

With respect to the pad 16-2, only the distance r(4,2) which is found to be −3 satisfies the above conditions. As such, the pad 16-2 and the slots 14-4 and 14-5 can be connected without jogs (referred to as a double pad net). The pad 16-2 can be selected as a power pad candidate. Similarly, the pad 16-3 and the slots 14-7 and 14-8 can be connected without jogs. With respect to the pad 16-4, a triple pad net is possible by using the slots 14-9, 14-10, and 14-11. Also, with respect to the pad 16-5, a triple pad net is possible by using the slots 14-12, 14-13, and 14-14.

In this case, an arrangement pattern corresponding to five pads and fourteen slots appears repeatedly. When the double pat net is required, all the pads 16 can be selected as power pad candidates. When the triple pat net is required, three pads 16-1, 16-4, and 16-5 can be selected as power pad candidates in one arrangement pattern.

As described above, when the power consumption or the circuit scale is provided, a chip size is estimated. The power consumption can be estimated from the circuit scale, and the number of power slots can be estimated from the power consumption. Since the number of slots to be allocated to the signal lines can be known from the number of signal lines, the total number slots for the signal lines and power supply can be obtained accordingly. The power pad candidates can be determined according to the above-mentioned simple procedure. By allocating the power pad candidates for the power pads, it is possible to increase the number of signal pads (signal terminals) while securing the power supply capability. In other words, it is possible to determine the power pads used for the power supply while increasing the signal pads and securing the power supply capability. Accordingly, such an event where a chip size must be increased due to a shortage of the signal pads can be prevented. It is therefore possible according to the method of routing interconnections of the present invention to provide a semiconductor IC device at a lower cost.

It is apparent that the present invention is not limited to the above embodiment, and that may be modified and changed without departing from the scope and spirit of the present invention.

1. A method of routing interconnections for a semiconductor integrated circuit device,
said semiconductor integrated circuit device having: a plurality of pads arranged in a first direction along a side of a chip; and a plurality of slots arranged in an inner area of said plurality of pads,
said method comprising:
(A) selecting such pads applicable to power supply as power pad candidates from said plurality of pads, each of said power pad candidates being arranged such that at least two interconnections substantially perpendicular to said first direction are connectable without bending from said each power pad candidate to two adjacent slots of said plurality of slots;
(B) specifying some of said power pad candidates as specific power pads each of which is used for supplying power to corresponding two adjacent slots of said plurality of slots; and
(C) routing at least one interconnection between said each specific power pad and said corresponding two adjacent slots.

2. The method according to claim 1,
wherein said (B) specifying comprises:
(b1) allocating a predetermined number of pads of said plurality of pads as power pads for power supply;
(b2) allocating other pads of said plurality of pads as signal pads for signal input;
(b3) allocating a certain number of said power pads as additional signal pads for signal input, when said signal pads are deficient by said certain number; and
(b4) selecting said certain number of said power pad candidates as said specific power pads.

3. The method according to claim 1,
wherein said plurality of pads are arranged at a regular interval, and
said plurality of slots are arranged to be contiguous with one another in said first direction.

4. The method according to claim 3,
wherein a width along said first direction of each of said plurality of pads is l,
a width along said first direction of each of said plurality of slots is m,
a width along said first direction of each of said two interconnections is s,
a first clearance width along said first direction of said each slot in a first side is α,
a second clearance width along said first direction of said each slot in a second side opposite to said first side is β,
said corresponding two adjacent slots include a first slot located in said first side and a second slot located in said second side,
a distance between an edge of said first side of said first slot and an edge of said first side of corresponding one of said power pad candidates is r,
wherein in said (A) selecting, said power pads candidates are selected such that following equations are satisfied:
l≧2s+α+β;
r+s+β≦m;
and
r+l≧m+α+s.

5. The method according to claim 2,
wherein said plurality of pads are arranged at a regular interval, and
said plurality of slots are arranged to be contiguous with one another in said first direction.

6. The method according to claim 5,
wherein a width along said first direction of each of said plurality of pads is l,
a width along said first direction of each of said plurality of slots is m,
a width along said first direction of each of said two interconnections is s,
a first clearance width along said first direction of said each slot in a first side is α,
a second clearance width along said first direction of said each slot in a second side opposite to said first side is β,
said corresponding two adjacent slots include a first slot located in said first side and a second slot located in said second side,
a distance between an edge of said first side of said first slot and an edge of said first side of corresponding one of said power pad candidates is r,
wherein in said (A) selecting, said power pads candidates are selected such that following equations are satisfied:
l≦2s+α+β;
r+s+β≧m;
and
r+l≦m+α+s.

7. The method according to claim 1,
wherein in said (C) routing, said two interconnections substantially perpendicular to said first direction are connected without bending between said each specific power pad and said corresponding two adjacent slots, respectively.

8. The method according to claim 2,
wherein in said (C) routing, said two interconnections substantially perpendicular to said first direction are connected without bending between said each specific power pad and said corresponding two adjacent slots, respectively.

9. The method according to claim 3,
wherein in said (C) routing, said two interconnections substantially perpendicular to said first direction are connected without bending between said each specific power pad and said corresponding two adjacent slots, respectively.

10. The method according to claim 4,
wherein in said (C) routing, said two interconnections substantially perpendicular to said first direction are connected without bending between said each specific power pad and said corresponding two adjacent slots, respectively.

11. The method according to claim 5,
wherein in said (C) routing, said two interconnections substantially perpendicular to said first direction are connected without bending between said each specific power pad and said corresponding two adjacent slots, respectively.

12. The method according to claim 6,
wherein in said (C) routing, said two interconnections substantially perpendicular to said first direction are connected without bending between said each specific power pad and said corresponding two adjacent slots, respectively.

13. The method according to claim 4,
wherein said α and said β are 0,
wherein in said (C) routing, one interconnection, which corresponds to said two interconnections and is substantially perpendicular to said first direction, is connected without bending between said each specific power pad and said corresponding two adjacent slots.

14. The method according to claim 6,
wherein said α and said β are 0,
wherein in said (C) routing, one interconnection, which corresponds to said two interconnections and is substantially perpendicular to said first direction, is connected without bending between said each specific power pad and said corresponding two adjacent slots.

15. A semiconductor integrated circuit device comprising:
a plurality of pads arranged in a first direction along a side of a chip, said plurality of pads including power pads user for power supply;
a plurality of slots arranged in an inner area of said plurality of pads; and
at least two interconnections substantially perpendicular to said first direction connected without bending between one of said plurality of power pads and two adjacent slots of said plurality of slots, respectively.

16. The semiconductor integrated circuit device according to claim 15,
wherein said plurality of pads are arranged at a regular interval, and
said plurality of slots are arranged to be contiguous with one another in said first direction.

17. The semiconductor integrated circuit device according to claim 16,
wherein a width along said first direction of each of said plurality of pads is l,
a width along said first direction of each of said plurality of slots is m,
a width along said first direction of each of said two interconnections is s,
a first clearance width along said first direction of said each slot in a first side is α,
a second clearance width along said first direction of said each slot in a second side opposite to said first side is β,
said two adjacent slots include a first slot located in said first side and a second slot located in said second side,
a distance between an edge of said first side of said first slot and an edge of said first side of said one pad is r,
wherein following equations are satisfied:
l≧2s+α+β;
r+s+β≦m;
and
r+l≧m+α+s.

18. A semiconductor integrated circuit device comprising:
a plurality of pads arranged in a first direction along a side of a chip, said plurality of pads including power pads user for power supply;
a plurality of slots arranged in an inner area of said plurality of pads; and
one interconnection substantially perpendicular to said first direction connected without bending between one of said plurality of power pads and two adjacent slots of said plurality of slots.

19. The semiconductor integrated circuit device according to claim 18,
wherein said plurality of pads are arranged at a regular interval, and
said plurality of slots are arranged to be contiguous with one another in said first direction.

20. The semiconductor integrated circuit device according to claim 19,
wherein a width along said first direction of each of said plurality of pads is l,
a width along said first direction of each of said plurality of slots is m,
a width along said first direction of each of said two interconnections is s,
said two adjacent slots include a first slot located in said first side and a second slot located in said second side,
a distance between an edge of said first side of said first slot and an edge of said first side of said one pad is r,
wherein following equations are satisfied:
l≧2s;
r+s≦m;
and
r+l≧m+s.
